(19) United States
(12) Patent Application Publication
(10) Pub. No.: US 2025/0296251 A1
(43) Pub. Date: Sep. 25, 2025

(54) ROBOT SYSTEM, CONTROL DEVICE, CONTROL METHOD, AND STORAGE MEDIUM

(71) Applicants: KABUSHIKI KAISHA TOSHIBA, Tokyo (JP); TOSHIBA INFRASTRUCTURE SYSTEMS & SOLUTIONS CORPORATION, Kawasaki-shi (JP)

(72) Inventors: Yoshifumi OKA, Yokohama (JP); Haruna ETO, Kawasaki (JP); Harutoshi CHATANI, Yokohama (JP); Kazunobu KONDA, Suginami (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi (JP)

(21) Appl. No.: 19/071,976

(22) Filed: Mar. 6, 2025

(30) Foreign Application Priority Data
Mar. 22, 2024 (JP) 2024-046444

(51) Int. Cl. B25J 18/00; B25J 9/16; B25J 13/08

(52) U.S. Cl. CPC B25J 18/00; B25J 9/1653; B25J 13/085; B25J 13/088

(57) ABSTRACT

According to one embodiment, a robot system includes a robot arm, a sensor, and a control device. A tool is detachably mounted to the robot arm. The sensor is configured to acquire data related to the tool. The control device is configured to control the robot arm. The control device is configured to perform at least a first determination of operating the tool after the tool is mounted, and determining whether or not the tool is mounted based on an operation result, and a second determination of determining whether or not the mounted tool matches a prescribed tool by using the data acquired by the sensor, the second determination being performed when the tool is determined to be mounted in the first determination.

### CROSS-REFERENCE TO RELATED APPLICATIONS

This application is based upon and claims the benefit of priority from Japanese Patent Application No. 2024-046444, filed on Mar. 22, 2024; the entire contents of which are incorporated herein by reference.

### FIELD

Embodiments of the invention generally relate to a robot system, a control device, a control method, and a storage medium.

### BACKGROUND

There is a robot system in which a tool is detachably mounted to a distal end of a robot arm. In such a robot system, it is desirable for the mounted tool to match a predesignated tool.

### BRIEF DESCRIPTION OF THE DRAWINGS

FIG. 1 is a perspective view showing a robot system according to an embodiment;

FIGS. 2A and 2B are perspective views showing a gripping tool and the distal end of a robot arm;

FIG. 3 is a perspective view showing an example of a gripping tool;

FIG. 4 is a perspective view showing another example of a gripping tool;

FIG. 5 is a perspective view showing another example of a gripping tool;

FIG. 6 is a flowchart describing an operation of the robot system according to the embodiment;

FIG. 7 is a flowchart showing a specific example of the processing of replacing the gripping tool, the first determination, and the second determination;

FIG. 8 is a flowchart describing another operation of the robot system according to the embodiment; and

FIG. 9 is a schematic view illustrating a hardware configuration.

### DETAILED DESCRIPTION

According to one embodiment, a robot system includes a robot arm, a sensor, and a control device. A tool is detachably mounted to the robot arm. The sensor is configured to acquire data related to the tool. The control device is configured to control the robot arm. The control device is configured to perform at least a first determination of operating the tool after the tool is mounted, and determining whether or not the tool is mounted based on an operation result, and a second determination of determining whether or not the mounted tool matches a prescribed tool by using the data acquired by the sensor, the second determination being performed when the tool is determined to be mounted in the first determination.

Embodiments of the invention will now be described with reference to the drawings. The drawings are schematic or conceptual; and the relationships between the thicknesses and widths of portions, the proportions of sizes between portions, etc., are not necessarily the same as the actual values thereof. The dimensions and/or the proportions may be illustrated differently between the drawings, even in the case where the same portion is illustrated. In the drawings and the specification of the application, components similar to those described thereinabove are marked with like reference numerals, and a detailed description is omitted as appropriate.

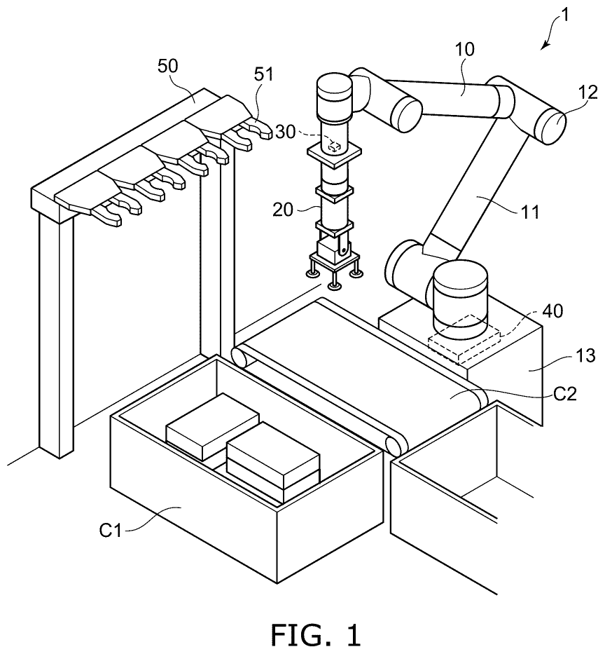

FIG. 1 is a perspective view showing a robot system according to an embodiment.

As shown in FIG. 1, the robot system 1 according to the embodiment includes a robot arm 10, a gripping tool 20, a sensor 30, and a control device 40.

The robot arm 10 includes multiple links 11 and multiple joints 12. In the example shown in FIG. 1, the robot arm 10 is a vertical articulated robot having six degrees of freedom. The robot arm 10 may be a horizontal articulated robot, a linear robot, an orthogonal robot, or a parallel link robot. The robot arm 10 may include a combination of two or more selected from a vertical articulated robot, a horizontal articulated robot, a linear robot, an orthogonal robot, and a parallel link robot. The robot arm 10 is mounted to a housing 13.

The housing 13 supports the robot arm 10 and is fixed with respect to the floor surface. A power supply device for driving electric actuators such as motors, a cylinder, tank, and compressor for driving fluid actuators, various safety mechanisms, etc., may be housed inside the housing 13.

The gripping tool 20 grips an object. For example, the gripping tool 20 grips the object by one of suction-gripping or pinching. In the example of FIG. 1, the gripping tool 20 includes multiple suction pads. The object is gripped by one or more suction pads suction-gripping the object. The gripping tool 20 is detachably mounted to the distal end of the robot arm 10.

The sensor 30 acquires data related to the gripping tool 20. In the example shown in FIG. 1, the sensor 30 is mounted to the distal end of the robot arm 10 and detects a force applied to the robot arm 10, the acceleration of the robot arm 10, and the angular velocity of the robot arm 10. For example, the sensor 30 is a force sensor that can detect a force, an acceleration sensor that can detect an acceleration, or an angular velocity sensor that can detect an angular velocity.

The sensor 30 may be a photoelectric sensor or a touch sensor. A photoelectric sensor includes a light projector and a light-receiving part, and detects whether or not light emitted from the light projector strikes the object. A touch sensor detects whether or not the object is contacted. When the photoelectric sensor is used, the control device 40 moves the gripping tool 20 in one direction while irradiating the light from the light projector on the gripping tool 20. The control device can calculate the position of the distal end of the robot arm 10. The control device 40 can calculate the length of the gripping tool 20 based on the relationship between the position of the photoelectric sensor and the position of the robot arm 10 when the light no longer strikes the gripping tool 20. A light curtain may be used in which multiple photoelectric sensors are arranged in one direction. When the touch sensor is used, the control device 40 operates the robot arm 10 and moves the gripping tool 20 until the gripping tool 20 contacts the touch sensor. The control device 40 can calculate the length of the gripping tool 20 based on the positional relationship between the touch sensor and the position of the robot arm 10 when the gripping tool 20 contacts the touch sensor.

Data of the appearance of the gripping tool 20 may be acquired as the data related to the gripping tool 20. For example, the sensor 30 may be an imaging device that includes an image sensor. The imaging device acquires an image of the gripping tool 20.

The control device 40 controls operations of the robot arm 10, the gripping tool 20, and the sensor 30. The control device receives data acquired by the sensor 30. The control device may be housed in the housing 13 or may be provided separately from the housing 13.

The robot system 1 shown in FIG. 1 is used as a handling system that can transfer an object. The robot arm 10 and the gripping tool 20 can be used as a picking robot. In a picking operation, the object is gripped, the gripped object is moved, and the object is placed at a prescribed position.

For example, the robot system 1 operates the robot arm and the gripping tool 20 to grip an object stored in a container C1. The robot system 1 transfers the object by operating the robot arm 10 in a state in which the object is gripped. The robot system 1 positions the object on a conveyor C2 and releases the object. The object that is placed on the conveyor C2 is transferred by the conveyor C2.

Multiple gripping tools 20 are located proximate to the robot system 1. The control device 40 operates the robot arm to mount one of the multiple gripping tools 20 to the robot arm 10.

In the example shown in FIG. 1, a rack 50 is located proximate to the robot system 1. The rack 50 includes multiple tool pockets 51. Each tool pocket 51 has U-shape opening and can hold the gripping tool 20.

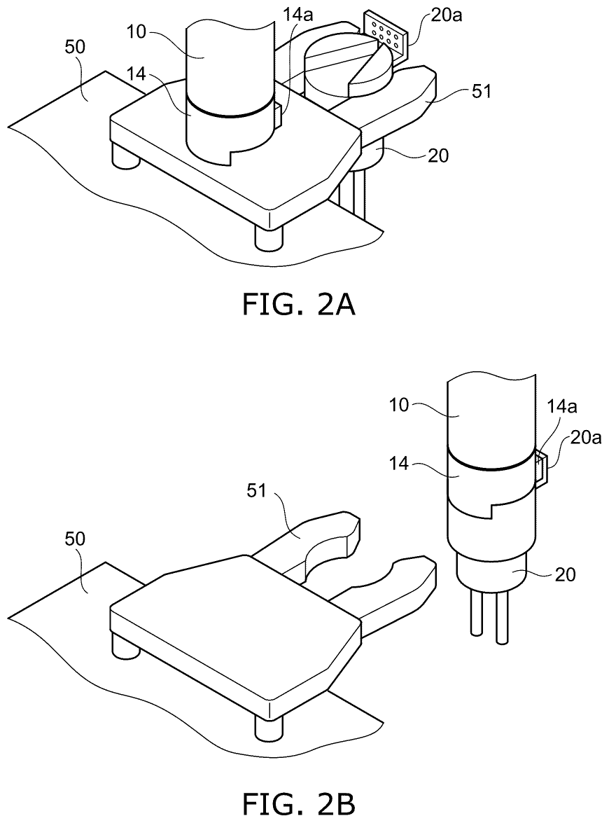

FIGS. 2A and 2B are perspective views showing the gripping tool and the distal end of the robot arm.

When mounting the gripping tool 20 to the robot arm 10, the distal end of the robot arm 10 is slid laterally toward the gripping tool 20 held by the tool pocket 51 as shown in FIG. 2A. The upper part of the gripping tool 20 engages a tool holder 14 of the distal end of the robot arm 10; and the gripping tool 20 is mounted to the robot arm 10 as shown in FIG. 2B.

In the illustrated example, a connector 14a is located at the side surface of the tool holder 14. Also, a connector 20a is located at the upper part of the gripping tool 20. The connector 14a and the connector 20a each include multiple electrodes. When the gripping tool 20 is mounted to the tool holder 14, the electrodes contact each other; and the connector 14a and the connector 20a are electrically connected. As a result, the gripping tool 20 and the control device 40 can communicate; and power is supplied to the gripping tool 20.

When detaching the gripping tool 20 from the robot arm 10, the opposite operation of mounting the gripping tool 20 to the robot arm 10 is performed. In other words, the mounted gripping tool 20 is slid toward the tool pocket 51. The gripping tool 20 is held by the tool pocket 51; and the gripping tool 20 is detached from the distal end of the robot arm 10.

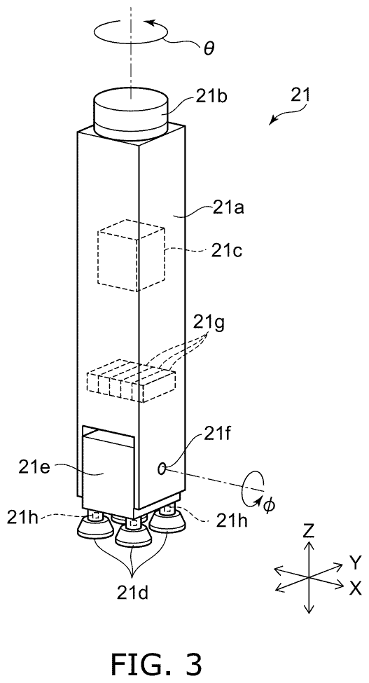

FIG. 3 is a perspective view showing an example of a gripping tool.

For example, the gripping tool 21 shown in FIG. 3 is used as the gripping tool 20. The gripping tool 21 grips the object by suction-gripping. As shown in FIG. 3, the gripping tool 21 includes a base 21a, a rotation axis 21b, a suction device 21c, suction pads 21d, a support part 21e, a rotation axis 21f, switch valves 21g, and a pressure sensor 21h.

The base 21a has a rectangular parallelepiped exterior shape and forms the contour of the gripping tool 21. The base 21a is coupled to the robot arm 10 via the rotation axis 21b. The rotation axis 21b rotatably couples the base 21a to the robot arm 10. The axial direction of the rotation axis 21b is substantially parallel to a Z-direction in which the base 21a and the distal part of the robot arm 10 are arranged. The rotation axis 21b includes a motor and can rotate the base 21a with respect to the robot arm 10 in a θ-direction and the opposite direction of the θ-direction.

The suction device 21c is located inside the base 21a. The suction device 21c is, for example, a vacuum pump. The suction device 21c communicates with the multiple suction pads 21d via hoses, etc. By driving the suction device 21c, the pressure inside each suction pad 21d drops below atmospheric pressure; and the object is suction-gripped by the suction pads 21d.

The support part 21e is coupled to the distal part of the base 21a via the rotation axis 21f. The axial direction of the rotation axis 21f is substantially perpendicular to the Z-direction. For example, the axial direction of the rotation axis 21f is perpendicular to the axial direction of the rotation axis 21b. The rotation axis 21f includes a motor and can rotate the support part 21e with respect to the base 21a in a ϕ-direction and the opposite direction of the ϕ-direction.

The support part 21e supports the multiple suction pads 21d. Each suction pad 21d has an opening; and the opening contacts the object when gripping. The suction pad 21d is flexible and can deform along the surface shape of the object. One end of the suction pad 21d is connected to a tube; and the other end of the suction pad 21d is open toward the side opposite to the support part 21e. The multiple suction pads 21d are arranged along two directions crossing each other. In the illustrated example, four suction pads 21d are arranged 2×2 along the X-direction and the Y-direction. The X-direction and the Y-direction are orthogonal to each other. The orientations of the multiple suction pads 21d are changed by operations of the rotation axis 21b or the rotation axis 21f.

The multiple switch valves 21g are provided respectively for the multiple suction pads 21d. Each switch valve 21g is set to the suction state or the release state. In the suction state, the suction device 21c communicates with the corresponding suction pad 21d. The internal pressure of the suction pad 21d is regulated by the suction device 21c. In the release state, the suction pad 21d and the suction device 21c are cut off from each other; and the suction pad 21d communicates with the outside of the gripping tool 21 (atmospheric pressure space). For example, the number of the switch valves 21g set to the suction state is adjusted according to the size of the object to be gripped.

The pressure inside the suction pad 21d is detected by the pressure sensor 21h. A negative pressure sensor can be used as the pressure sensor 21h. For example, the multiple pressure sensors 21h respectively measure the pressures inside the multiple suction pads 21d.

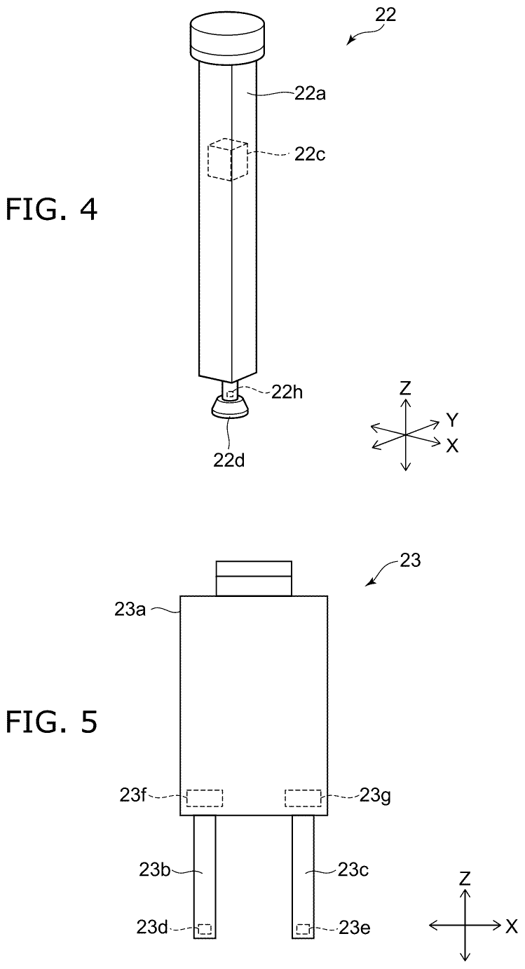

FIG. 4 is a perspective view showing another example of a gripping tool.

The gripping tool 22 shown in FIG. 4 may be used as the gripping tool 20. Similarly to the gripping tool 21, the gripping tool 22 grips the object by suction-gripping. However, the structure of the gripping tool 22 is different from the structure of the gripping tool 21. As shown in FIG. 4, the gripping tool 22 includes a base 22a, a suction device 22c, a suction pad 22d, and a pressure sensor 22h.

Similarly to the base 21a, the base 22a forms the contour of the gripping tool 22. The base 22a is fixed with respect to the distal part of the robot arm 10. The suction device 22c is located inside the base 21a and can exhaust the interior of the suction pad 21d. The suction pad 22d is fixed with respect to the base 22a. The gripping tool 22 does not include a rotation axis, and so the orientation of the suction pad 22d with respect to the distal part of the robot arm 10 is fixed. The pressure sensor 22h detects the pressure inside the suction pad 22d.

The gripping tool 22 differs from the gripping tool 21 in that the rotation axis is not included. In other words, the gripping tool 22 does not include a motor. Also, the gripping tool 22 includes only one suction pad 22d. As a result, only one pressure sensor 22h is included, and a switch valve is not included.

FIG. 5 is a perspective view showing another example of a gripping tool.

The gripping tool 23 shown in FIG. 5 may be used as the gripping tool 20. The gripping tool 23 grips the object by pinching. The gripping tool 23 includes a base 23a, a support part 23b, a support part 23c, a sensor 23d, a sensor 23e, a motor 23f, and a motor 23g.

The base 23a forms the contour of the gripping tool 23. The base 23a is fixed with respect to the distal part of the robot arm 10. The support part 23b and the support part 23c are mounted to the base 23a. The support part 23b and the support part 23c are plate-shaped or rod-shaped and extend along the Z-direction. Other than the illustrated example, the gripping tool 23 may include a structure that includes three or more support parts.

The sensor 23d and the sensor 23e are located respectively at the distal ends of the support parts 23b and 23c. The support part 23b and the support part 23c are elastic in the Z-direction. When the support part 23b deforms in the Z-direction, the sensor 23d detects the deformation amount. When the support part 23c deforms in the Z-direction, the sensor 23e detects the deformation amount. For example, the sensor 23d and the sensor 23e each include a linear pulse encoder, a force sensor, a strain sensor, or a laser displacement meter.

The support part 23b and the support part 23c are separated from each other in the X-direction. The motor 23f and the motor 23g respectively drive the support part 23b and the support part 23c along the X-direction. The distance between the support part 23b and the support part 23c is changed by operations of the motors 23f and 23g. In other words, the support part 23b and the support part 23c are opened and closed by the motor 23f and the motor 23g.

For example, the robot system 1 replaces the gripping tool according to the article to be gripped. By using the gripping tool 20 that is suited to grip each object, more diverse objects can be stably gripped.

For example, a computer (a higher-level system) other than the robot system 1 transmits, to the gripping tool 20, an instruction of the object to be transferred, the number of objects, and the gripping tool 20 to be used. When receiving the instruction, the control device 40 generates a motion plan. The motion plan includes a plan of the motion necessary to replace the gripping tool 20, the motion for transferring using the replaced gripping tool 20, etc. The control device 40 replaces the gripping tool 20 as necessary and grips and transfers the object.

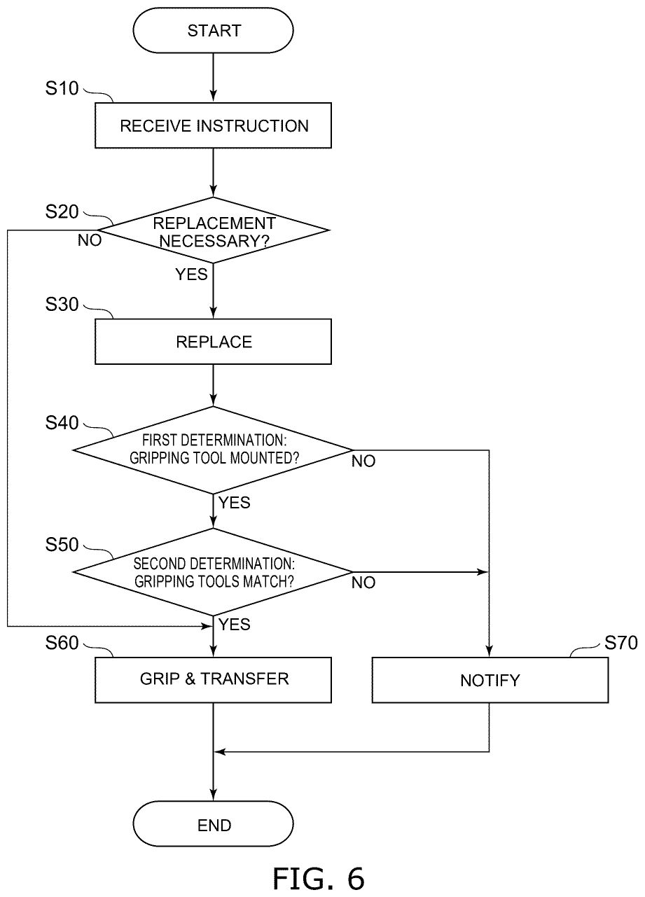

FIG. 6 is a flowchart describing an operation of the robot system according to the embodiment.

First, the control device 40 receives an instruction from a higher-level system (step S10). Then, the control device 40 determines whether or not it is necessary to replace the gripping tool 20 (step S20). When it is determined that it is necessary to replace the gripping tool 20, the control device 40 replaces the gripping tool 20 (step S30). Specifically, the gripping tool 20 that is already mounted to the robot arm 10 is detached; and another gripping tool 20 is mounted to the robot arm 10.

After the other gripping tool 20 is mounted to the robot arm 10, the control device 40 performs a first determination (step S40). In the first determination, the control device 40 operates the gripping tool 20. The operation includes communicating with an electrical component included in the gripping tool 20, driving the electrical component, etc. Based on the operation result, the control device 40 determines whether or not the gripping tool 20 is mounted to the robot arm 10.

When the gripping tool 20 is determined to be mounted to the robot arm 10 in the first determination, the control device 40 performs a second determination (step S50). In the second determination, the control device 40 receives data acquired by the sensor 30. The control device 40 uses the data to acquire characteristic information of characteristics of the gripping tool 20. The characteristic information is the weight of the gripping tool 20, the length of the gripping tool 20, the appearance of the gripping tool 20, etc. The control device 40 compares the characteristic information to characteristic information of a prescribed gripping tool 20. Specifically, it is determined whether or not the characteristic information acquired from the data of the sensor 30 matches the characteristic information of the gripping tool 20 designated in step S10. As a result, it is determined whether or not the mounted gripping tool 20 matches the designated gripping tool 20.

When the mounted gripping tool 20 is determined to match the prescribed gripping tool 20 in the second determination, the control device 40 causes the robot arm 10 to grip and transfer the object by using the mounted gripping tool 20 (step S60). When it is determined in step S20 that replacement of the gripping tool 20 is unnecessary, the object is gripped and transferred by the gripping tool 20 that is already mounted.

When the gripping tool 20 is determined not to be mounted to the robot arm 10 in the first determination, or when it is determined that the mounted gripping tool 20 does not match the designated gripping tool 20 in the second determination, the control device 40 stops the operation of the robot arm 10 and outputs a notification (step S70). For example, the notification is transmitted to a preregistered terminal device. The notification may be output from an output device installed proximate to the robot system 1. For example, a message that notifies the abnormality is displayed by a monitor. Or, a sound that notifies the abnormality may be output from a speaker. A light that notifies the abnormality may be output from a light-emitting device.

More specific examples of the processing will now be described.

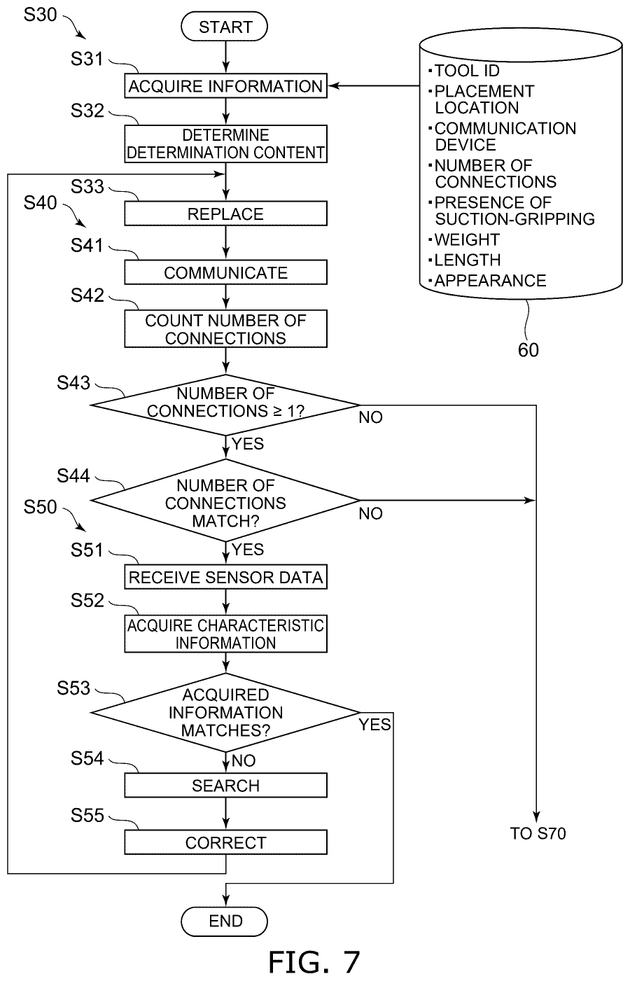

FIG. 7 is a flowchart showing a specific example of the processing of replacing the gripping tool, the first determination, and the second determination.

After the replacement of the gripping tool 20 is determined, the control device 40 acquires the information of the gripping tool to be replaced (step S31). The information of the gripping tool 20 is registered in a tool master data 60. The tool master data 60 includes information of the tool ID, the placement location, the communication device, the number of connections, the presence of suction-gripping, the weight, the length, and the appearance for each gripping tool 20.

The “tool ID” is data for identifying each gripping tool 20. The “placement location” indicates the location of the rack 50 at which each gripping tool 20 is placed. The “communication device” indicates the type of electrical component that is located in the gripping tool 20 and can communicate. For example, the electrical component can communicate with a motor, a pressure sensor, etc. The “number of connections” is the number of devices connected when the gripping tool 20 is mounted, and is registered for each communication device. The “presence of suction-gripping” indicates whether or not the gripping tool 20 can suction-grip the object. The “weight” and the “length” are, respectively, the weight of the gripping tool 20 and the length of the gripping tool 20 in any one direction. The “appearance” is information indicating the appearance of the gripping tool 20. For example, images of the gripping tools 20 are registered as the information of the appearance.

When the information of the gripping tool 20 is acquired, the control device 40 determines the content of the first determination and the content of the second determination (step S32). Specifically, the control device 40 determines the information to be used in the first and second determinations according to the type of the gripping tool 20 to be replaced. Then, the control device 40 determines the conditions necessary for the first determination and the conditions necessary for the second determination.

For example, when the gripping tool 20 to be replaced includes a suction mechanism, and the gripping tool 20 includes a motor and a pressure sensor, the control device 40 determines the use of the number of motors and the number of pressure sensors in the first determination. The control device 40 determines the conditions used in the second determination according to the type of the sensor 30. When the sensor 30 includes a force sensor, an acceleration sensor, or an angular velocity sensor and the weight of the gripping tool 20 is calculated, the control device 40 determines the use of the weight of the gripping tool 20 in the second determination. When the sensor 30 includes a photoelectric sensor or a touch sensor and the length of the gripping tool 20 is calculated, the control device determines the use of the length of the gripping tool 20 in the second determination. When the sensor 30 includes an imaging device and an image of the gripping tool 20 is acquired, the control device 40 determines the use of information of the appearance of the gripping tool 20 in the second determination.

Subsequently, the control device 40 replaces the gripping tool 20 by operating the robot arm 10 (step S33).

In the first determination (step S40), the control device operates the gripping tool 20 and communicates with an electrical component included in the gripping tool 20 (step S41). For example, when the electrical component is a motor, the control device 40 transmits a prescribed signal (a first signal) to the motor. The motor is configured to respond to the reception of the signal by returning a prescribed signal (a second signal). When receiving the second signal, the control device 40 determines that communication is possible with the motor to which the first signal was transmitted. Or, the control device 40 may transmit a drive signal to the motor; and a current value or a torque detected by the motor may be acquired. When receiving the current value or the torque, the control device 40 determines that communication is possible with the motor to which the drive signal was transmitted. When the electrical component is a pressure sensor, the control device 40 causes the pressure sensor to detect a pressure. The control device 40 determines whether or not the difference between the detected pressure and a preregistered pressure is less than a threshold. When the difference is less than the threshold, the control device determines that communication is possible with the pressure sensor.

The control device 40 counts the number of connections for each electrical component (step S42). The control device 40 determines whether or not the number of connections is not less than 1 (step S43).

For example, when the gripping tool 20 includes a motor and a pressure sensor, the control device 40 determines whether or not the number of connections of the motor is not less than 1, and whether or not the number of connections of the pressure sensor is not less than 1. When the number of connections of the motor is 0 or the number of connections of the pressure sensor is 0, this indicates that the control device 40 cannot correctly communicate with the motor or the pressure sensor. In other words, this indicates that the gripping tool 20 is not mounted to the robot arm 10. In such a case, there is a possibility that the gripping tool 20 is not mounted to the robot arm 10; or, the gripping tool 20 is mounted to the robot arm 10, but the gripping tool 20 is not correctly connected to the robot arm 10.

When the number of connections is not less than 1 in step S43, the control device 40 may determine whether or not the number counted in step S42 matches the number of connections of the prescribed gripping tool 20 (step S44). The control device can acquire, from the tool master data 60, the information of the electrical components included in the designated gripping tool 20, the number of electrical components, etc.

For example, when the designated gripping tool 20 includes one motor and two pressure sensors, the number of connections of the motor is “1” and the number of connections of the pressure sensor is “2” in the count of step S42. When the counted number of connections of the motor is not “1” or the counted number of connections of the pressure sensor is not “2”, the control device 40 determines that the mounted gripping tool is different from the prescribed gripping tool 20.

In the second determination (step S50), the control device receives the data acquired by the sensor 30 (step S51). The control device 40 uses the data to acquire characteristic information of the characteristics of the gripping tool 20 (step S52). The characteristic information is the weight of the gripping tool 20, the length of the gripping tool 20, the appearance of the gripping tool 20, etc. For example, when the sensor 30 includes a force sensor, an acceleration sensor, or an angular velocity sensor, the control device 40 calculates the weight of the gripping tool 20 based on the force, acceleration, or angular velocity that is detected. When the sensor 30 includes a photoelectric sensor or a touch sensor, the control device 40 uses the detection result of the sensor 30 to calculate the length of the gripping tool 20. When the sensor 30 includes an imaging device, the image that is acquired by the imaging device is used as the characteristic information. The gripping tool 20 may be recognized in the image and cut out from the image; and the image that is cut out may be used as the characteristic information.

The control device 40 determines whether or not the characteristic information (the weight, the length, or the image) acquired in step S52 matches the characteristic information preregistered in the tool master data 60 (step S53). When the acquired characteristic information matches the preregistered characteristic information, the control device 40 determines that the mounted gripping tool 20 matches the prescribed gripping tool 20.

When the mounted gripping tool 20 is determined not to match the designated gripping tool 20, the control device 40 may identify the mounted gripping tool 20. The control device 40 searches, among the gripping tools 20 registered in the tool master data 60, for information of the gripping tool 20 that matches the number of connections counted in step S42 and the characteristic information acquired in step S52 (step S54). When the gripping tool 20 that matches is found, the control device 40 determines that the matching gripping tool 20 is mounted to the robot arm 10.

The control device 40 corrects the information of the placement location registered in the tool master data 60 (step S55). Specifically, the control device 40 registers that the gripping tool 20 found in the search is placed at the placement location of the directly-previous replacement operation. Subsequently, the control device 40 may perform the replacement operation of the gripping tool 20 again. In such a case, the control device 40 replaces the gripping tool 20 mounted to the robot arm 10 with one of the gripping tools 20 placed in the rack 50. The method for selecting the gripping tool 20 to be replaced is arbitrary. After replacing, the first determination (step S40) and the second determination (step S50) are performed. As a result, it is determined whether or not the replaced gripping tool 20 matches the prescribed gripping tool 20. The replacement of the gripping tool 20 is repeated until the replaced gripping tool 20 matches the prescribed gripping tool 20. Also, the placement locations of the gripping tools 20 are updated to the correct information in the process of repeating the replacement.

When the mounted gripping tool 20 is determined to match the designated gripping tool 20 in step S53, the object is gripped and transferred (step S60).

Advantages of the embodiment will now be described.

When the gripping tool 20 is replaced, it is desirable for the gripping tool 20 to be appropriately mounted to the robot arm 10. Examples of a method for confirming that the gripping tool is mounted to the robot arm 10 include a method in which the gripping tool 20 is operated, and it is determined whether or not the gripping tool 20 is mounted to the robot arm 10 based on the operation result of the gripping tool 20. By confirming that the gripping tool 20 is mounted to the robot arm 10, the task in which the robot system 1 uses the gripping tool 20 can be appropriately performed.

When, however, using multiple gripping tools 20 that are similar to each other, cases may occur where the mounted gripping tool 20 does not match the predesignated gripping tool 20, even when the gripping tool 20 is determined to be mounted to the robot arm 10. As an example, multiple gripping tools 20 that each include a motor and a pressure sensor are placed on the rack 50. In such a case, communication with the motor and the pressure sensor is confirmed in the confirmation operation when any of the gripping tools 20 is mounted. Accordingly, even when the gripping tool 20 is determined to be mounted based on the operation result, there is a possibility that the mounted gripping tool 20 is different from the designated gripping tool 20.

According to the embodiment, the control device performs the first determination after the gripping tool 20 is mounted. In the first determination, the gripping tool 20 is operated, and it is determined whether or not the gripping tool 20 is mounted based on the operation result. Then, when the gripping tool 20 is determined to be mounted in the first determination, the control device 40 performs the second determination. In the second determination, it is determined whether or not the gripping tool matches the designated gripping tool by using the data acquired by the sensor 30.

According to the first determination, it is determined whether or not the gripping tool 20 is mounted to the robot arm 10. However, even when the gripping tool 20 is determined to be mounted to the robot arm 10, there is a possibility that the mounted gripping tool 20 does not match the designated gripping tool 20. When the gripping tool 20 is determined to be mounted in the first determination, it can be determined whether or not the mounted gripping tool 20 matches the designated gripping tool 20 by performing the second determination.

According to the second determination, it also can be determined whether or not the mounted gripping tool 20 is in a prescribed state. For example, when the object is gripped and transferred and then released by the gripping tool 20, there are cases where at least a part of the object catches on the gripping tool 20 or adheres to the gripping tool 20. Also, there are cases where the gripping tool 20 is placed on the rack 50 in a state in which the object is attached to the gripping tool 20. When the object is attached to the gripping tool 20, a subsequent gripping operation may be obstructed. According to the second determination, such a gripping tool 20 to which the object is attached also can be discriminated not to be the designated gripping tool 20. For example, when the object is attached to the gripping tool 20, the weight of the gripping tool 20, the length of the gripping tool 20, or the appearance of the gripping tool 20 may be different from preregistered characteristic information. In other words, even when the mounted gripping tool 20 itself matches the designated gripping tool 20, the gripping tool 20 is determined to be different from the designated gripping tool 20 if an object is attached to the mounted gripping tool 20. As a result, it is determined whether or not the mounted gripping tool is in the prescribed state (i.e., the normal state in which an object is not attached).

When the sensor 30 detects the angular velocity, the acceleration, or the force applied to the robot arm 10, the control device may cause the robot arm 10 to perform a prescribed operation in the second determination. In such a case, the detection result of the sensor 30 when the robot arm 10 performs the prescribed operation is preregistered in the tool master data 60. The preregistered detection result is acquired in the normal state in which an object is not attached to the gripping tool 20. The control device 40 determines whether or not the mounted gripping tool 20 matches the designated gripping tool 20 by comparing the detection result of the sensor 30 when the robot arm 10 performs the prescribed operation and the preregistered detection result.

For example, time-series data of the force, acceleration, or angular velocity is acquired when performing the prescribed operation. The control device 40 calculates the similarity between the acquired time-series data and the preregistered time-series data. When the similarity is greater than a prescribed threshold, the control device 40 determines that the mounted gripping tool 20 matches the designated gripping tool 20.

According to the embodiment, it can be determined whether or not the gripping tool 20 mounted to the robot arm 10 matches the prescribed gripping tool 20. As a result, the robot system 1 can be more appropriately operated.

There is a method for determining whether or not the mounted gripping tool 20 matches the prescribed gripping tool by providing an identification circuit for each gripping tool 20. According to this method, by communicating with the identification circuit, the control device 40 can determine whether or not the gripping tool 20 is mounted to the robot arm 10 and whether or not the mounted gripping tool 20 matches the prescribed gripping tool 20. However, in this method, it is necessary to incorporate an identification circuit in each gripping tool 20 and to add electrical contacts for the gripping tool 20 to communicate with the identification circuit. The cost of the gripping tool 20 is increased thereby. Also, when the identification circuit is used, it can be determined whether or not the mounted gripping tool 20 itself matches the designated gripping tool 20; however, a state in which an object is caught on the gripping tool 20, etc., cannot be determined. According to the embodiment, without adding an identification circuit and electrical contacts to the gripping tool 20, it can be determined not only whether or not the mounted gripping tool 20 matches the designated gripping tool 20, but also whether or not the mounted gripping tool 20 is in the prescribed state.

The gripping tool 20 may be mechanically chucked to the robot arm 10, or may be chucked using air or an electric component. The method for mounting the gripping tool 20 to the robot arm 10 also is arbitrary. The gripping tool 20 may be mechanically mounted to the robot arm 10 by sliding the robot arm 10 with respect to the gripping tool 20. The robot arm 10 may be stopped in a state in which the robot arm 10 contacts a part of the gripping tool 20; and chucking with air or an electric component may be performed.

Favorably, the gripping tool 20 is mechanically chucked. In such a case, as shown in FIGS. 2A and 2B, the gripping tool can be mounted to the robot arm 10 by sliding the distal end of the robot arm 10 with respect to the gripping tool 20. Also, the gripping tool 20 can be detached from the robot arm 10 by sliding the gripping tool 20 toward the tool pocket 51. As a result, the time necessary for replacing the gripping tool 20 can be less than chucking by air or an electric component.

The robot system 1 may include multiple sensors 30. For example, one of the multiple sensors 30 is a sensor for acquiring one selected from the group consisting of a weight, a length, and an appearance. Another one of the multiple sensors 30 is a sensor for acquiring another one selected from the group. By including the multiple sensors 30, even when the characteristic information of two gripping tools 20 overlaps, other characteristic information can be used to discriminate the gripping tools 20. Accordingly, it can be more reliably determined whether or not the mounted gripping tool 20 matches the designated gripping tool 20.

In such a case, it is favorable for the control device 40 to select characteristic information that does not mutually overlap among the characteristic information of the multiple gripping tools 20. When the sensor 30 is acquiring data, it is necessary to stop the robot arm 10 or for the robot arm 10 to perform a prescribed operation. The control device 40 acquires data from the sensor 30 that obtains the characteristic information selected in the second determination. As a result, only the necessary sensor 30 can acquire the data. The time necessary for the second determination can be reduced, and the subsequent start of the gripping operation can be earlier.

When there are multiple sets of characteristic information that do not mutually overlap, the control device 40 selects the sensor 30 among the multiple sensors 30 that has the shortest data acquisition time. As an example, it takes 1 second to calculate the weight of the gripping tool 20 by a force sensor measuring the force. It takes 1 second to calculate the length of the gripping tool 20 by using a photoelectric sensor. It takes 3 seconds for the gripping tool 20 to be stationary at a prescribed position and for an imaging device to image the gripping tool 20. When the gripping tool 20 can be identified by using either the data of the force sensor or the data of the imaging device, the force sensor that has a shorter data acquisition time is selected. As a result, the time necessary for the second determination can be reduced, and the subsequent start of the gripping operation can be earlier.

When the gripping tool 20 is determined not to be mounted in the first determination, another gripping tool 20 may be selected, and the control device 40 may mount the other gripping tool 20 to the robot arm 10. The first determination is re-performed after performing the operation of mounting the other gripping tool 20 to the robot arm 10. When the other gripping tool 20 is determined to be mounted in the first determination and the mounted gripping tool 20 is determined to match the selected gripping tool 20 in the second determination, the other gripping tool 20 is used to grip and transfer the object. As a result, the robot system 1 can automatically recover from an error; and the work efficiency of the robot system 1 can be increased.

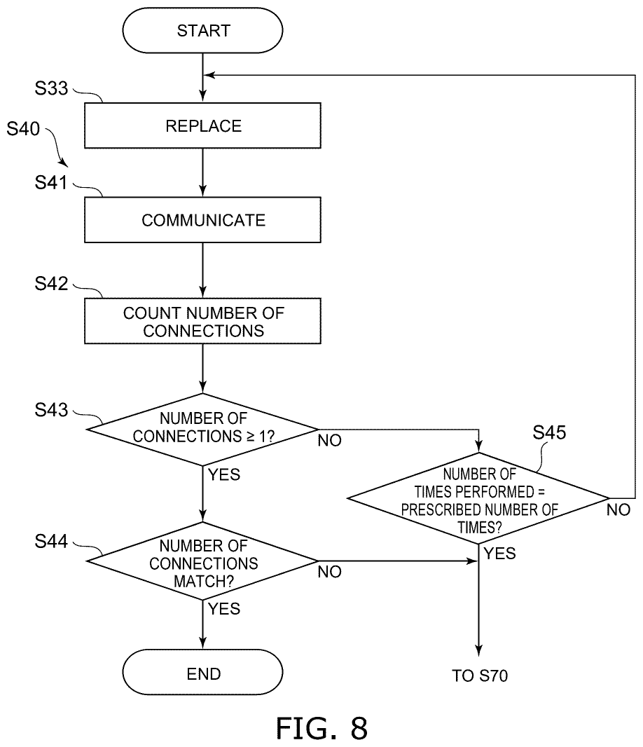

FIG. 8 is a flowchart describing another operation of the robot system according to the embodiment.

When the gripping tool 20 is determined not to be mounted in the first determination, the control device 40 may re-perform the operation of mounting the gripping tool 20 to the robot arm 10. The control device 40 re-performs the first determination after performing the operation of mounting the gripping tool 20 to the robot arm 10. When the gripping tool 20 is determined not to be mounted even in the first determination that is performed again, the control device 40 may re-perform the operation of mounting the gripping tool 20 to the robot arm 10. The operation of mounting the gripping tool 20 and the first determination may be repeated.

FIG. 8 shows processing after step S32 and before step S50 is performed. For example, as shown in FIG. 8, when the number of connections is determined not to be not less than 1 in step S43, the control device 40 determines whether or not the number of times that the replacement of the gripping tool 20 has been performed has reached a prescribed number of times (step S45). When the number of times that the replacement has been performed has not reached the prescribed number of times, or when the number counted in step S44 does not match the number of connections of the prescribed gripping tool 20, step S70 is performed, and a notification is output. According to the processing shown in FIG. 8, there is a possibility that the gripping tool 20 may be correctly mounted to the robot arm 10 by re-performing the replacement operation.

According to the embodiments above, an example is illustrated in which a gripping tool is mounted to a robot arm. The embodiments of the invention are not limited to the example. For example, the tool that is mounted to the robot arm may be a tool for patterning a workpiece. The patterning may include polishing, cutting, piercing, cleaning, etc. The tool may include a screw driver for turning a screw, etc. When such a tool is mounted to the robot arm, it can be determined whether or not the tool mounted to the robot arm matches a prescribed tool by performing the first determination and the second determination.

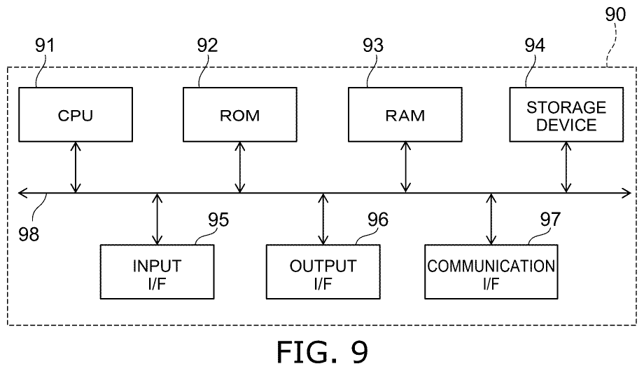

FIG. 9 is a schematic view illustrating a hardware configuration.

For example, a computer 90 shown in FIG. 9 is used as the control device 40. The computer 90 includes a CPU 91, ROM 92, RAM 93, a storage device 94, an input interface 95, an output interface 96, and a communication interface 97.

The ROM 92 stores programs controlling operations of the computer 90. The ROM 92 stores programs necessary for causing the computer 90 to realize the processing described above. The RAM 93 functions as a memory region into which the programs stored in the ROM 92 are loaded.

The CPU 91 includes a processing circuit. The CPU 91 uses the RAM 93 as work memory to execute the programs stored in at least one of the ROM 92 or the storage device 94. When executing the programs, the CPU 91 executes various processing by controlling configurations via a system bus 98.

The storage device 94 stores data necessary for executing the programs and/or data obtained by executing the programs. The storage device 94 includes at least one selected from a hard disk drive (HDD) and a solid state drive (SSD).

The input interface (I/F) 95 can connect the computer 90 and an input device. The input I/F 95 is, for example, a serial bus interface such as USB, etc. The CPU 91 can read various data from the input device via the input I/F 95.

The output interface (I/F) 96 can connect the computer 90 and an output device. The output I/F 96 is, for example, an image output interface such as Digital Visual Interface (DVI), High-Definition Multimedia Interface (HDMI (registered trademark)), etc. The CPU 91 can transmit data to the output device via the output I/F 96.

The communication interface (I/F) 97 can connect the computer 90 and a server outside the computer 90. The communication I/F 97 is, for example, a network card such as a LAN card, etc. For example, the CPU 91 can read various data from the server via the communication I/F 97.

The processing performed by the control device 40 may be realized by one computer 90 or may be realized by collaboration of multiple computers 90.

The processing of the various data described above may be recorded, as a program that can be executed by a computer, in a magnetic disk (a flexible disk, a hard disk, etc.), an optical disk (CD-ROM, CD-R, CD-RW, DVD-ROM, DVD+R, DVD+RW, etc.), semiconductor memory, or another non-transitory computer-readable storage medium.

For example, the information that is recorded in the recording medium can be read by a computer (or an embedded system). The recording format (the storage format) of the recording medium is arbitrary. For example, the computer reads a program from the recording medium and causes a CPU to execute the instructions recited in the program based on the program. In the computer, the acquisition (or the reading) of the program may be performed via a network.

Embodiments of the invention include the following features.

### Feature 1

A robot system, including:
a robot arm, a tool being detachably mounted to the robot arm;
a sensor configured to acquire data related to the tool; and
a control device configured to control the robot arm, the control device being configured to perform at least
   a first determination of
      operating the tool after the tool is mounted, and
      determining whether or not the tool is mounted based on an operation result, and
   a second determination of determining whether or not the mounted tool matches a prescribed tool by using the data acquired by the sensor, the second determination being performed when the tool is determined to be mounted in the first determination.

### Feature 2

The system according to feature 1, in which
the tool is a gripping tool configured to grip an object, and
the robot arm uses the gripping tool to transfer the object.

### Feature 3

The system according to feature 2, in which
in the first determination, the control device:
   counts a number of electrical components that are included in the gripping tool and are capable of communicating;
   determines that the gripping tool is mounted to the robot arm when the counted number is not less than 1; and
   determines that the gripping tool is not mounted to the robot arm when the counted number is 0.

### Feature 4

The system according to feature 3, in which
the control device determines that the gripping tool is different from the prescribed tool when the counted number is not less than 1 and the counted number does not match a prescribed number.

### Feature 5

The system according to any one of features 2 to 4, in which
the control device uses the data acquired by the sensor to acquire characteristic information including at least one selected from the group consisting of a weight of the gripping tool, a length of the gripping tool, and an appearance of the gripping tool, and
in the second determination, the control device determines whether or not the gripping tool matches the prescribed tool by comparing the characteristic information and preregistered information.

### Feature 6

The system according to any one of features 2 to 5, in which
the sensor detects at least one selected from an angular velocity, an acceleration, and a force applied to the robot arm,
the control device calculates a weight of the gripping tool based on the data of the sensor, and
in the second determination, the control device determines whether or not the gripping tool matches the prescribed tool by comparing a difference between the calculated weight and a preregistered weight to a threshold.

### Feature 7

The system according to any one of features 2 to 6, in which
in the first determination, the control device:
   transmits a first signal to one or more motors included in the gripping tool,
   receives a second signal transmitted from each of the one or more motors,
   counts a number of the motors from which the second signal is received, and
   determines whether or not the gripping tool is mounted based on the counted number of the motors.

### Feature 8

The system according to any one of features 2 to 7, in which
the gripping tool is configured to grip the object by suction-gripping, and
in the first determination, the control device:
   receives a pressure detected by one or more pressure sensors included in the gripping tool;
   counts a number of the pressure sensors for which a difference between the detected pressure and a preregistered pressure is less than a threshold; and
   determines whether or not the gripping tool is mounted based on the counted number of the pressure sensors.

### Feature 9

The system according to any one of features 2 to 8, in which
the sensor detects at least one selected from an angular velocity, an acceleration, and a force applied to the robot arm, and
in the second determination, the control device determines whether or not the mounted tool matches the prescribed tool by comparing a preregistered detection result of the prescribed operation and a detection result of the sensor when the robot arm performs a prescribed operation.

### Feature 10

The system according to any one of features 2 to 9, in which
the control device detaches the mounted tool and mounts another gripping tool to the robot arm when the mounted tool is determined not to match the prescribed tool in the second determination.

### Feature 11

The system according to any one of features 2 to 10, in which
the control device performs the first and second determinations after the gripping tool is mounted to the robot arm and before the object is gripped by the gripping tool.

### Feature 12

The system according to any one of features 2 to 11, in which
the control device mounts the gripping tool to a distal end of the robot arm by sliding the distal end laterally toward an end part of the gripping tool.

### Feature 13

The system according to any one of features 1 to 12, including:
a plurality of the sensors,
the control device
   acquiring characteristic information related to a plurality of the tools, the plurality of tools being preregistered,
   selecting characteristic information that does not mutually overlap among the characteristic information of the plurality of tools, and
   in the second determination, acquiring the data from one of the plurality of sensors configured to obtain the selected characteristic information.

### Feature 14

The system according to feature 13, in which
when there is a plurality of sets of the characteristic information that does not mutually overlap, the control device selects the sensor among the plurality of sensors having a shortest acquisition time of the data.

### Feature 15

The system according to any one of features 1 to 14, in which
when the tool is determined not to be mounted in the first determination, the control device re-performs an operation of mounting the tool to the robot arm.

### Feature 16

The system according to feature 15, in which
the control device:
   re-performs the first determination after the operation of mounting the tool to the robot arm is performed; and
   mounts another one of the tools to the robot arm when a number of times that the operation of mounting the tool is performed is greater than a prescribed number of times.

### Feature 17

The system according to any one of features 1 to 16, in which
when the mounted tool does not match the prescribed tool in the second determination, the control device identifies the mounted tool and corrects information of a placement location of the identified tool.

### Feature 18

A control device,
the control device being configured to control a robot arm,
a tool being detachably mounted to the robot arm,
the control device being configured to perform at least:
   a first determination of
      operating the tool after the tool is mounted, and
      determining whether or not the tool is mounted based on an operation result; and
   when the tool is determined to be mounted in the first determination, a second determination of determining whether or not the tool matches a prescribed tool by using data related to the tool,
the data related to the tool being acquired by a sensor.

### Feature 19

A control method of a robot system,
the robot system including:
   a robot arm, a tool being detachably mounted to the robot arm; and
   a sensor configured to acquire data related to the tool,
the control method including:
   a first determination of
      operating the tool after the tool is mounted, and
      determining whether or not the tool is mounted based on an operation result; and
   when the tool is determined to be mounted in the first determination, a second determination of determining whether or not the tool matches a prescribed tool by using the data acquired by the sensor.

### Feature 20

A program, when executed by a computer, causing the computer to perform the control method according to feature 19.

### Feature 21

A storage medium, configured to store the program according to feature 20.

According to embodiments of the invention, a robot system, a control device, a control method, a program, and a storage medium are provided in which it can be determined whether or not a tool mounted to a robot arm matches a prescribed tool.

In the specification, “or” means that “at least one” of the components listed in the text can be employed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention. Moreover, above-mentioned embodiments can be combined mutually and can be carried out.

What is claimed is:

1. A robot system, comprising:
a robot arm, a tool being detachably mounted to the robot arm;
a sensor configured to acquire data related to the tool; and
a control device configured to control the robot arm, the control device being configured to perform at least
a first determination of
operating the tool after the tool is mounted, and
determining whether or not the tool is mounted based on an operation result, and
a second determination of determining whether or not the mounted tool matches a prescribed tool by using the data acquired by the sensor, the second determination being performed when the tool is determined to be mounted in the first determination.

2. The system according to claim 1, wherein
the tool is a gripping tool configured to grip an object, and
the robot arm uses the gripping tool to transfer the object.

3. The system according to claim 2, wherein
in the first determination, the control device:
counts a number of electrical components that are included in the gripping tool and are capable of communicating;
determines that the gripping tool is mounted to the robot arm when the counted number is not less than 1; and
determines that the gripping tool is not mounted to the robot arm when the counted number is 0.

4. The system according to claim 3, wherein
the control device determines that the gripping tool is different from the prescribed tool when the counted number is not less than 1 and the counted number does not match a prescribed number.

5. The system according to claim 2, wherein
the control device uses the data acquired by the sensor to acquire characteristic information including at least one selected from the group consisting of a weight of the gripping tool, a length of the gripping tool, and an appearance of the gripping tool, and
in the second determination, the control device determines whether or not the gripping tool matches the prescribed tool by comparing the characteristic information and preregistered information.

6. The system according to claim 2, wherein
the sensor detects at least one selected from an angular velocity, an acceleration, and a force applied to the robot arm,
the control device calculates a weight of the gripping tool based on the data of the sensor, and
in the second determination, the control device determines whether or not the gripping tool matches the prescribed tool by comparing a difference between the calculated weight and a preregistered weight to a threshold.

7. The system according to claim 2, wherein
in the first determination, the control device:
transmits a first signal to one or more motors included in the gripping tool,
receives a second signal transmitted from each of the one or more motors,
counts a number of the motors from which the second signal is received, and
determines whether or not the gripping tool is mounted based on the counted number of the motors.

8. The system according to claim 2, wherein
the gripping tool is configured to grip the object by suction-gripping, and
in the first determination, the control device:
receives a pressure detected by one or more pressure sensors included in the gripping tool;
counts a number of the pressure sensors for which a difference between the detected pressure and a preregistered pressure is less than a threshold; and
determines whether or not the gripping tool is mounted based on the counted number of the pressure sensors.

9. The system according to claim 2, wherein
the sensor detects at least one selected from an angular velocity, an acceleration, and a force applied to the robot arm, and
in the second determination, the control device determines whether or not the mounted tool matches the prescribed tool by comparing a preregistered detection result of the prescribed operation and a detection result of the sensor when the robot arm performs a prescribed operation.

10. The system according to claim 2, wherein
the control device detaches the mounted tool and mounts another gripping tool to the robot arm when the mounted tool is determined not to match the prescribed tool in the second determination.

11. The system according to claim 2, wherein
the control device performs the first and second determinations after the gripping tool is mounted to the robot arm and before the object is gripped by the gripping tool.

12. The system according to claim 2, wherein
the control device mounts the gripping tool to a distal end of the robot arm by sliding the distal end laterally toward an end part of the gripping tool.

13. The system according to claim 1, comprising:
a plurality of the sensors,
the control device
acquiring characteristic information related to a plurality of the tools, the plurality of tools being preregistered,
selecting characteristic information that does not mutually overlap among the characteristic information of the plurality of tools, and
in the second determination, acquiring the data from one of the plurality of sensors configured to obtain the selected characteristic information.

14. The system according to claim 13, wherein
when there is a plurality of sets of the characteristic information that does not mutually overlap, the control device selects the sensor among the plurality of sensors having a shortest acquisition time of the data.

15. The system according to claim 1, wherein
when the tool is determined not to be mounted in the first determination, the control device re-performs an operation of mounting the tool to the robot arm.

16. The system according to claim 15, wherein
the control device:
re-performs the first determination after the operation of mounting the tool to the robot arm is performed; and
mounts another one of the tools to the robot arm when a number of times that the operation of mounting the tool is performed is greater than a prescribed number of times.

17. The system according to claim 1, wherein
when the mounted tool does not match the prescribed tool in the second determination, the control device identifies the mounted tool and corrects information of a placement location of the identified tool.

18. A control device,
the control device being configured to control a robot arm,
a tool being detachably mounted to the robot arm,
the control device being configured to perform at least:
a first determination of
operating the tool after the tool is mounted, and
determining whether or not the tool is mounted based on an operation result; and
when the tool is determined to be mounted in the first determination, a second determination of determining whether or not the tool matches a prescribed tool by using data related to the tool,
the data related to the tool being acquired by a sensor.

19. A control method of a robot system,
the robot system including:
a robot arm, a tool being detachably mounted to the robot arm; and
a sensor configured to acquire data related to the tool,
the control method comprising:
a first determination of
operating the tool after the tool is mounted, and
determining whether or not the tool is mounted based on an operation result; and
when the tool is determined to be mounted in the first determination, a second determination of determining whether or not the tool matches a prescribed tool by using the data acquired by the sensor.

20. A non-transitory computer-readable storage medium, configured to:
store a program,
the program, when executed by a computer, causing the computer to perform the control method according to claim 19.
